(19) United States
(12) Patent Application Publication
(10) Pub. No.: US 2026/0298539 A1
(43) Pub. Date: Oct. 1, 2026

(54) METHOD FOR FLAME CONTROL IN A ROTARY LIME KILN

(71) Applicant: VALMET AB, Sundsvall (SE)

(72) Inventors: Søren HEINESEN, Copenhagen (DK); Hannibal NIELSEN, Copenhagen S (DK); Susanne WIND, Frederikssund (DK); Charles BROOKS WIND, Frederikssund (DK); Johnni STEN LARSEN, Vallensbaœk Strand (DK); Dan MINCULESCU, København NV (DK)

(73) Assignee: VALMET AB, Sundsvall (SE)

(21) Appl. No.: 19/163,118

(22) PCT Filed: Mar. 11, 2024
(86) PCT No.: PCT/SE2024/050221

§ 371 Date: Sep. 8, 2025

(30) Foreign Application Priority Data
Mar. 9, 2023 (SE) 2330117-9

(51) Int. Cl. F27B 7/36; F27B 7/34; F27D 99/00

(52) U.S. Cl. CPC F27B 7/362; F27B 7/34; F27D 99/0033

(57) ABSTRACT

A rotary lime kiln includes a tubular lime kiln body having a first end comprising a burner and a second end adapted to receive lime to be burnt in the rotary lime kiln. A boost gas injector is arranged below the burner, at a lower part of the lime kiln. A method for controlling flame stability in a rotary lime kiln is also disclosed.

### TECHNICAL FIELD

The disclosure pertains to a rotary lime kiln comprising a tubular lime kiln body having a first end comprising a burner and a second end adapted to receive lime to be burnt in the rotary lime kiln.

A method for controlling flame stability in a rotary lime kiln is also disclosed herein.

### BACKGROUND

A lime kiln is used, e.g., in a pulp mill to convert calcium carbonate CaCO₃ into burnt lime CaO as part of a chemical recovery system in the pulp mill.

The chemicals are recovered from smelt which is withdrawn from a recovery boiler in the pulp mill. The smelt is dissolved in a dissolving tank to form green liquor, which is subsequently recausticized in a causticizer and recycled as white liquor to a digester of the pulp mill. In the causticizer, sodium carbonate in the green liquor reacts with burnt lime, CaO.

Rotary furnaces used as lime kilns typically have a substantially cylindrical or tubular shape, the length of the cylinder being much greater than its width. The lime kiln can typically have a diameter of about 2-5 meters and being 10 to 40 meters longer than its width. The furnace rotates around a rotation axis which is inclined with respect to the horizontal plane and corresponds to the longitudinal axis of the cylinder. Lime kilns usually have their longitudinal axis of the cylinder at about 2°-5°slope. The material to be pyroprocessed in the furnace is fed to the furnace at its upper end and travels downwards through the furnace under the effect of gravity. The furnace comprises a burner assembly at its lower end for the combustion of main fuel with combustion oxidizer so as to generate the heat necessary for pyroprocessing. The flame generated by the burner assembly is directed substantially along the longitudinal direction of the furnace. The flue gases generated in the furnace are evacuated from the furnace at its upper end.

The pyroprocessed material, which in this case is lime, is transferred from the furnace to an air-cooled material cooler. In order to reutilize the thermal energy of the hot cooling air leaving the cooler, it is known to use the hot cooling air as a secondary oxidizer for the combustion of the main fuel. In that case, the burner assembly injects the main fuel and primary combustion oxidizer into the furnace so as to generate partial combustion of the main fuel with the primary combustion oxidizer. Hot air from the material cooler is fed to the furnace to provide secondary combustion oxidizer for the substantially complete combustion of said main fuel.

There has been suggested several arrangements and methods for controlling the combustion process in a lime kiln. In WO 2021/198 571 is disclosed a method for reducing combustion temperature or thermal radiation within a rotary lime kiln. The lime kiln has a burner supplied with fuel and primary air and the cooling effect is achieved by supplying calcium carbonate containing particles via a separate lance to the flame or the surrounding area around the flame, preferably to the upper part of the flame. A purpose of reducing the temperature is to reduce NOx formation. In WO 2014/188 119 is disclosed another lime kiln having a burner with primary air and fuel supplied to the burner. The burner is arranged in such a way that there is supply of more primary air to the burner in the lower half than in the upper half of the burner. In this way there will be more secondary air withdrawn in the lower half as well. In WO 2015 is a method for operating a rotary furnace disclosed. The method aims to reduce ring formation in the kiln. The object is achieved by continuously or discontinuously varying a parameter in the injection of a fluid in addition to the primary air and fuel. By varying the fluid injection parameter, it will be possible to change the thermal distribution within the rotary furnace and thus move the zones where ringformation occurs.

Even though the above cited documents describe methods aiming at controlling the combustion process, there is still a desire to further improve the performance and controllability of the burning process and the flame in a lime kiln at operation. At the high temperatures in the lime kiln, such as at temperatures of 900° C. or more, mechanical durability and reduction of NOx-formation are particular concerns.

The heat for the lime kiln is supplied from kiln burners that can be designed for any type of gaseous, liquid, or solid fuel, such as biofuel, or a combination of these.

Flame stabilization and emission control in a rotary lime kiln are regulated by fuel injection, primary air injection and position and inclination of the burner.

When using biofuel, the biofuel quality, in particular the moisture content of the biofuel, affects flame stability, CO and NOx formation. Optimal conditions for obtaining flame stability and low CO and NOx formation have been found difficult or even impossible to achieve within normal operating conditions.

An object of the present invention is to provide a kiln construction offering improved flame stability control and lowered emissions. A further object is to provide a method offering improved flame stability control and lowered emissions.

### SUMMARY

One or more of the above and further objects may be achieved with a rotary lime kiln according to the independent device claim and a method for controlling flame stability in a rotary lime kiln according to independent method claim. Variations of the disclosure are set out in the dependent claims.

The rotary lime kiln disclosed herein comprises a tubular lime kiln body having a first, lower end comprising a burner and a second, upper end adapted to receive lime to be burnt in the rotary lime kiln boost gas injector. The rotary lime kiln further having a top part, being the upper half of the tubular lime kiln body when divided by a plane along the longitudinal axis, and a bottom part, being the lower half of the tubular main kiln body. The bottom part thus being the half pipe closest to the ground and the top part being the half pipe furthest from the ground. The burner comprises a fuel pipe and a primary air pipe for providing air and fuel to the burner to be combusted and heating the kiln. The fuel and primary air are mixed in a mixing zone located at the outlets of the fuel and primary air. The lime kiln further comprises a secondary air inlet admitting secondary air via a product cooler into the lime kiln. The secondary air inlet admits air into the lime kiln at the first, lower end at a location between the walls of the lime kiln and the burner upstream of the mixing zone of the primary air and the fuel.

The lime kiln also includes a boost gas injector which is arranged at or in the vicinity of the first end for admitting boost gas into the lime kiln. The boost air is introduced at high speed, from 140 m/s and higher, in order to create a boost gas jet stream penetrating far into the lime kiln, preferably more than 20-30 meters and even up to 60-80 meters, in order to have an effect on the burner process and the flame for a long distance. The boost gas injector or injectors are arranged to direct its boost jet gas stream in a direction towards the second end in the bottom part of the lime kiln. The boost gas injectors need not to have their outlets directing the gas stream to be completely aligned with the longitudinal axis of the lime kiln but can be somewhat inclined relative the longitudinal axis. However, in order to penetrate far into the lime kiln, the direction cannot deviate too much from the axial direction and shall not deviate more than 10-15 degrees maximum. In general, the deviation is less than 5 degrees and essentially along the axial direction of the lime kiln.

The boost gas injector could be arranged to be located below the burner and direct the gas stream essentially along the axial direction of the lime kiln. The boost gas injector is preferably arranged such that it creates a boost gas jet stream directed between the product bed and the flame.

The boost gas injector is preferably designed to have an outlet which is upstream in the axial direction of the mixing region of the burner, preferably a distance corresponding to at least 1 diameter of the tubular lime kiln body upstream of the burner mixing zone. The burner mixing zone is starting where the front of the burner is located and where the outlets or nozzles of the fuel pipe and primary air pipe are where the fuel and combustion air start to mix and react.

In order to create a gas jet being able to penetrate far into the lime kiln, the the diameter of the outlet of the boost gas injector should preferably have a minimum size. If the diameter is too small, the gas will loss momentum quickly and not penetrate enough into the lime kiln. The diameter is at least 5 cm (or the cross-sectional area of the outlet is at least 80 cm2), more preferably 7 cm (cross sectional area at least 155 cm2) and most preferably 10 cm (cross sectional area 315 cm2).

According to one design of the lime kiln, the cross-sectional area of the outlet of the boost gas injector is designed to be equal to or smaller than the cross-sectional area of an boost gas pipe leading to the boost gas injector outlet. Hence, the section of the boost gas pipe in the burner in the lime kiln leading to the boost gas injector have a larger cross sectional area for at least some portion of the boost gas pipe, preferably at least for half the length of the pipe in the lime kiln. The cross-sectional area of the outlet of the boost gas injector can be designed to be reduced to be at least 30 percent smaller than the cross-sectional area of the boost gas pipe, preferably at least 45 % smaller and most preferably at least 60 % smaller.

The rotary lime kiln can comprise more than 1 boost air injector and there can be two or more boost gas injectors arranged below the burner, in the lower part of the lime kiln. The boost gas injectors may also be arranged above the burner directing a boost gas jet stream in the bottom part of the lime kiln.

In certain instance, e.g. for large rotary lime kilns, it may be advantageous to use at least two boost gas injectors and arrange the outlets of the at least two injectors such that they are located at different locations in the axial direction. It can be an advantage to let the outlet of one of these injectors be located closer to the first, lower end of the lime kiln where usually the inlet of secondary air is locate while the other outlet for jet boost gas is located further away from the first end and penetrating further into the lime kiln in order to make the jet boost gas stream penetrate further into the lime kiln. Thus, two or more boost gas injectors, such as 2 to 10 boost gas injectors, may be arranged below the burner at the lower part of the lime kiln.

The boost gas injector(s) may be arranged in a kiln door at the first end of the tubular lime kiln body.

The boost gas injector(s) may also form an integral part of the burner. They can be completely integrated in the burner or only partly integrated, e.g. having the gas pipe integrated and allowing the outlet to be outside the burner.

Disclosed herein is also a method for controlling flame stability in a rotary lime kiln. The method is suitably performed in a lime kiln comprising a tubular lime kiln body having a first end comprising a burner and a second end adapted to receive a product to be burnt in the rotary lime kiln. The product to be burnt is fora example lime which mainly comprises calcium oxide. The rotary lime kiln has a bottom part and a top part when divided in a plane parallel with the centre axis of the tubular lime kiln splitting the tubular lime kiln body in a bottom part comprising the half of the tube closest to the ground and a top part being the comprising the other half pipe. The lime kiln is further provided with a fuel pipe and a primary air pipe for providing air and fuel to the burner. In this context, when referring to the burner is meant those parts and arrangements in the lime kiln which are present for delivering fuel and primary air to the lime kiln. The lime kiln further comprises a secondary air inlet admitting secondary air into the lime kiln at the first, lower end. The inlet for secondary air is preferably arranged to have an intake for delivering secondary air all around the circumference of the tubular lime kiln body at the first lower end of the lime kiln. The secondary air is admitted to the lime kiln at a position upstream of a mixing zone of the burner where the outlets of primary air and fuel are located. Hence the mixing zone is at the tip of the burner where the outlets or nozzles of the primary air pipe and fuel pipe are located. The lime kiln further comprises a boost gas injector arranged at or in the vicinity of the first, lower end of the lime kiln. The boost jet gas stream is directed along or somewhat inclined relative the axial direction of the lime kiln to provide a boost jet gas stream in the longitudinal direction of the lime kiln. The boost gas injectors are arranged and controlled such that the injected gas creates a boost jet gas stream in the bottom part of the lime kiln, between the flame from the burner and a product bed, in the rotary lime kiln. Hence, the boost jet gas stream will flow close to a product bed at the bottom of the lime kiln and being directed along or somewhat inclined relative the axial direction along the longitudinal extension direction of the lime kiln. The purpose of the boost jet gas stream is to produce a a lower pressure, a low-pressure zone, in the bottom part of the lime kiln suppressing the flame to move towards the upper wall at the top part of the lime kiln. It is thus important to provide gas at a high velocity to penetrate into the lime kiln far enough to reach zones where the flame have a high tendency to be unstable.

As set out herein, flame stabilization and emission control in a rotary lime kiln are conventionally regulated by fuel injection, primary air injection and position and inclination of the burner in the lime kiln. These factors are also important for obtaining a specified product quality. The boost gas which is injected above the product bed serves to contribute to flame stabilization by creating a low pressure in the bottom region close to the product bed and thereby to reduce NOx formation and thermal wear of the refractory liner in the lime kiln body. The control of the flame contributes to reduce numbers and intensity of temperature spikes in the lime kiln.

In order to provide a low pressure zone at the bottom of the lime kiln, the boost gas need to have a speed sufficiently high, and thus a sufficiently high momentum, to penetrate deep into the lime kiln. According to one embodiment, he velocity of the boost jet gas stream at the outlet of the boost gas injector shall be at least above 120 m/s, preferably above 140 m/s and most preferably above 150 m/s. In addition to the speed of the boost air, it is also desired to have a rather large outlet of the boost gas injector.

The velocity of the boost jet gas stream at the outlet of the boost gas injector is preferably designed to exceed the velocity of the primary air at the primary air outlet.

The flow of gas through the boost gas injector is rather small compared to the total volume of gas injected to the lime kiln. According to one embodiment, the volume of gas injected through the boost gas injector is less than 15 % of the total gas flow of primary air, secondary air and boost gas, preferably less than 10 percent and most preferably less than 7 %. The volumes of the gas are calculated as being volumes of gas having same temperature.

In order to control the flame stability, the flow of boost gas is essentially constant. When the lime kiln is operating, it is under normal circumstances desired to keep the volume flow from the boost gas injector at constant level. According to one embodiment, the flow through the boost gas injector is kept at the same level during at least 80 % of the time when the lime kiln is operating. By keeping the volume flow from the boost gas injector at constant level is meant to keep the volume flow rate not differing more than 15 % from a set value of the flow under normal operation.

The gas used for the boost gas may be selected as desired. A suitable gas to be used is air which thus may be used as additional combustion gas. However, other gases which may be used are flue gases or oxygen enriched air.

### BRIEF DESCRIPTION OF THE DRAWING

The method as disclosed herein will be further explained hereinafter with reference to the appended drawing wherein:

FIG. 1 shows a schematic drawing of the burner end of a prior art rotary lime kiln.

FIG. 2 shows a schematic drawing of a rotary lime kiln according to a first embodiment of the invention.

FIG. 3a shows a second version of the first embodiment of the invention

FIG. 3b shows a third version of the first embodiment according to the invention

FIG. 4 shows a second embodiment of the invention

### DETAILED DESCRIPTION

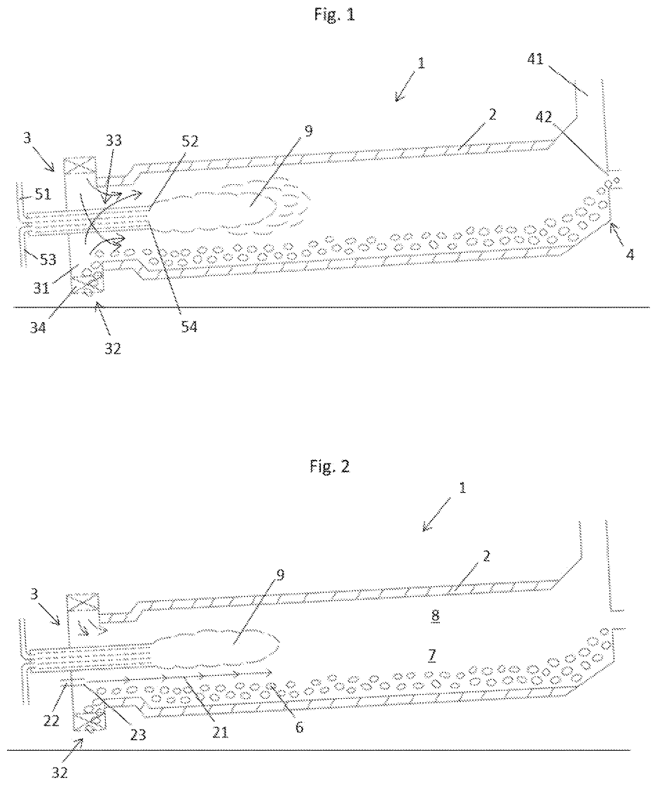

With reference to FIG. 1, a cross sectional side view of a schematic drawing of a rotary lime kiln 1 is shown. To be noted, in particular the relation between the length of the tubular lime kiln body 2 and the diameter of the lime kiln body 2 do not correspond to actual relations, the lime kiln 1 is usually 10 to 50 times longer than the diameter of the lime kiln body 2. The tubular lime kiln body 2 is arranged to be slightly inclined along its longitudinal axis such that the rotary lime kiln comprises a first, lower end 3 being located vertically below a second, upper end 4. The first lower end 3 comprises a fuelled burner 5. The purpose of the burner 5 is to dry and heat the product bed 6, e. g lime in order to convert calcium oxide (CaO) to calcium carbonate (CaCO3). The product to be treated in the lime kiln enters into the lime kiln 1 via a product inlet 42 In the second, upper end 4 and is discarded from the lime kiln via a product outlet 31 in the first, lower end 3. The tubular lime kiln body 2 comprises a bottom part 7 which is the lower half pipe of the tubular lime kiln body 1 and a top part 8 which is the upper half pipe of the tubular lime kiln body 1. At the product outlet 31 is arranged a product cooler 34 where secondary air 33, entering the lime kiln via a secondary air inlet 32, is heated by heat exchange with the hot product. The lime kiln further comprises one or several fuel pipes 51 as well as one or several primary air pipes 53 arranged to provide fuel and combustion air to the burner 5. Fuel and primary air are injected to the lime kiln 1 at the tip of the burner 5 via one or several fuel outlets 52 and primary air outlets 54. The primary air and fuel are injected in a mainly axial direction such that a flame 9 propagating mainly along the longitudinal direction of the lime kiln 1 is created when the fuel and air is mixed.

In FIG. 2 is disclosed a lime kiln 1 which has been provided with an arrangement according to a first embodiment of the invention. The lime kiln in FIG. 2 comprises all the features disclosed in FIG. 1 but differs in that the lime kiln in FIG. 2 is provided with an boost gas pipe 22 having a boost pipe outlet 23 for delivering a boost jet gas stream 21 into the lime kiln 1. The boost gas pipe 22 is located in the first, lower end 3 in the bottom part 7 of the lime kiln 1. The boost jet gas stream 21 is directed along the longitudinal axis of the lime kiln body 2 between the flame 9 and the product bed 6 at the bottom of the lime kiln 6.

The boost jet gas stream 21 has the effect of creating a low pressure in the bottom part 7 below the flame 9 such that the flame 9 is kept more concentrated and lower as compared to the flame 9 in FIG. 1. The boost gas pipe 22 only penetrates a small distance into the lime kiln 1 and the boost pipe outlet 23 is located at the same position in the axial direction as the secondary air inlet 32. It may be advantageous to place the boost pipe outlet 23 at this position in order to withdraw secondary air 33 into the lime kiln.

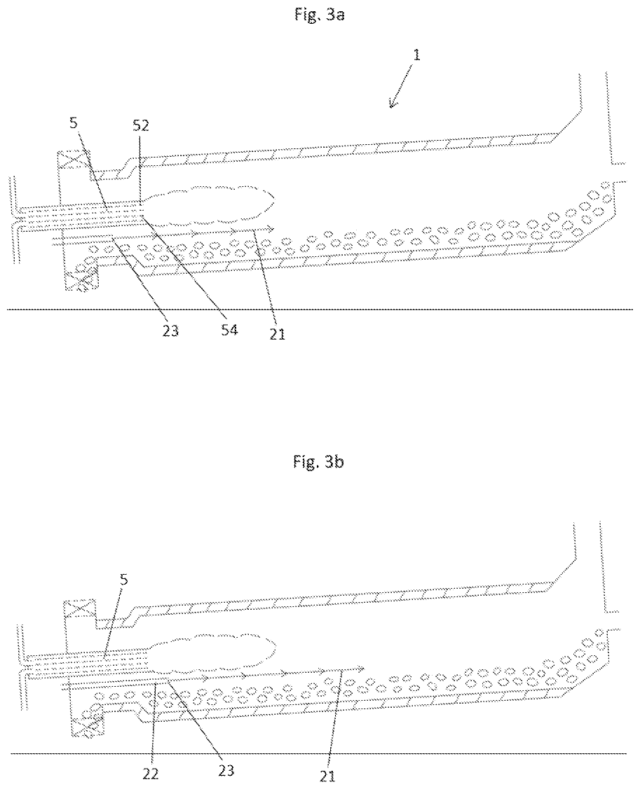

In FIG. 3a is disclosed a second version of the embodiment of the invention in FIG. 2 where the boost gas pipe 22 penetrates further into the lime kiln 1 than in the embodiment disclosed in FIG. 2. The remaining features are the same as disclosed in FIG. 2. By allowing the boost gas pipe to penetrate further into the lime kiln 1, the boost jet gas stream 21 can penetrate even further into the lime kiln 1. The boost pipe outlet 23 is located behind the tip of the burner 5, preferably a distance corresponding to the diameter of the burner, e.g. to have the boost pipe outlet 23 located 50 cm upstream in the axial direction of where the tip of the burner 5 comprising the fuel outlet 52 and primary air outlet 54 are located.

In FIG. 3b is disclosed a third version of the embodiment of the invention in FIG. 2 in which the boost gas pipe 22 is introduced even further into the lime kiln 1 such that the boost pipe outlet 23 is located downstream of the tip of the burner 5 in the axial direction of the lime kiln 1. This means that the boost jet gas stream 21 can penetrate even further into the lime kiln which is beneficial. However, the boost gas pipe 22 and boost pipe outlet 23 will be subjected to a hotter environment and the cooling need to be enhanced in order to make such an arrangement work.

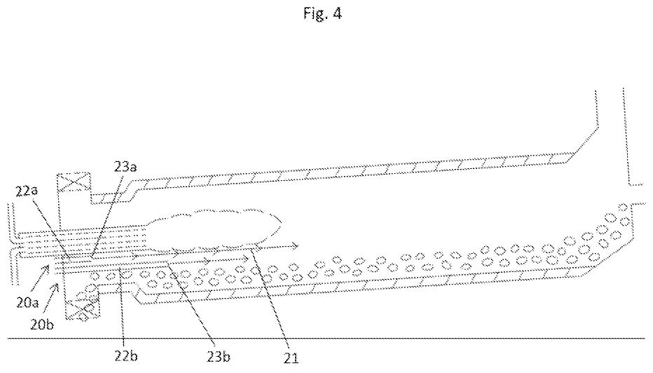

In FIG. 4 is disclosed a second embodiment of the invention where a first boost gas pipe 22a and a second boost gas pipe 22b are present in the limekiln 1. The first boost gas pipe 22a penetrates only a short distance into the lime kiln 1 as disclosed in FIG. 2 while the second boost gas pipe penetrates further into the lime kiln but not passing the tip of the burner 5 as disclosed in the arrangement in FIG. 3a. Hence, both the boost pipe outlets 23a, 23b are located upstream of the tip of the burner 5 but at different distances along the longitudinal axis of the lime kiln 1. Both pipes 22a, 22b are pointing in the same direction and there will be essentially one boost jet gas stream 21 created by the two boost air injectors 20a, 20b.

The air boost injectors 20, 20a, 20b shall be designed to provide a boost jet gas stream 21 which can penetrate and last a distance corresponding to approximately 30 to 60 times the diameter of the burner tip. The burner tip may have a diameter from about 0.5 meters up to 1.5 meters rendering a desire to provide a boost jet gas stream reaching from about 25 meters for small lime kilns up to 80 meters or more for larger lime kilns. It is a desire to provide a boost jet gas stream which last and penetrates a long distance into the lime kiln.

1-15. (canceled)

16. A rotary lime kiln comprising:
a tubular lime kiln body having a first, lower end comprising a burner and a second, upper end adapted to receive lime to be burnt in the rotary lime kiln, the rotary lime kiln having a top part and a bottom part, said burner comprising a fuel pipe and a primary air pipe for providing air and fuel to the burner, said lime kiln further comprising a secondary air inlet admitting secondary air via a product cooler into the lime kiln at the first, lower end
wherein a boost gas injector is arranged in a vicinity of the first end for admitting boost gas into the lime kiln, said boost gas injector comprising a boost gas pipe and a boost pipe outlet arranged to direct its boost jet gas stream in a direction towards the second end in the bottom part of the lime kiln.

17. The rotary lime kiln according to claim 16, wherein the boost gas injector is located below the burner and configured to direct the air (gas) stream essentially along the axial direction of the lime kiln.

18. The rotary lime kiln according to claim 16, wherein the boost gas injector has an outlet which is upstream (in the axial direction) of the mixing region of the burner.

19. The rotary lime kiln according to claim 16, wherein a diameter of the outlet of the boost gas injector is at least 5 cm.

20. The rotary lime kiln according to claim 16, wherein a cross-sectional area of the outlet of the boost gas injector is essentially equal to or smaller than a cross-sectional area of the boost gas pipe.

21. The rotary lime kiln according to claim 20, wherein the cross-sectional area of the outlet of the boost gas injector is reduced to be at least 30 percent smaller than the cross-sectional area of the boost gas pipe.

22. The rotary rotary lime kiln according to claim 16, wherein two or more boost gas injectors are arranged below the burner, at the lower part of the lime kiln.

23. The rotary rotary lime kiln according to claim 22 wherein the outlet of the at least two injectors are located at different locations in the axial direction.

24. The rotary rotary lime kiln according to claim 16, wherein the boost gas injector is arranged in a kiln door at the first end of the tubular lime kiln body.

25. A method for controlling flame stability in a rotary lime kiln comprising a tubular lime kiln body having a first end comprising a burner and a second end adapted to receive lime to be burnt in the rotary lime kiln, the rotary lime kiln having a bottom part and a top part, said lime kiln further comprising a fuel pipe and a primary air pipe for providing air and fuel to the burner, said lime kiln further comprising a secondary air inlet admitting secondary air into the lime kiln at the first, lower end and upstream of a mixing zone of the burner where outlets of primary air and fuel are located, wherein a boost gas injector comprising a boost gas pipe and a boost pipe outlet is arranged in the vicinity of the first end for injecting boost gas into the lime kiln, said boost jet gas stream being directed along or inclined relative the axial direction wherein boost gas is injected create a boost jet gas stream in the bottom part of the lime kiln between the flame from the burner and a product bed in the rotary lime kiln so as to produce a lower pressure in the bottom part of the lime kiln suppressing the flame to move towards the wall of the lime kiln in the top part.

26. The method according to claim 25, wherein a velocity of the boost jet gas stream at the outlet of the boost gas injector is above 120 m/s.

27. The method according to claim 25, wherein a velocity of the boost jet gas stream at the outlet of the boost gas injector exceeds the velocity of the primary air at the primary air outlet.

28. The method according to claim 25, wherein a flow of gas through the boost gas injector is less than 15 % of the total gas flow of primary air, secondary air and boost gas.

29. The method according to claim 25, wherein a flow of boost gas is kept at the same level during at least 80 % of the time when the lime kiln is operating.

30. The method according to claim 25, wherein the gas used for the boost gas consists of, or mainly comprises, air.
